(19) United States
(12) Patent Application Publication
(10) Pub. No.: US 2005/0286102 A1
(43) Pub. Date: Dec. 29, 2005

(54) Information processing using lasing material

(76) Inventor: Thomas Lieske, Milwaukee, WI (US)

Correspondence Address: GEHRKE & ASSOCIATES, S.C., 123 N. 86th ST, WAUWATOSA, WI, 53226, US

(21) Appl. No.: 10/867,522

(22) Filed: Jun. 14, 2004

(51) Int. Cl. G06E 3/00

(52) U.S. Cl. 359/107

(57) ABSTRACT

A system of information processing includes a processor that has lasing material configured to route an input along a pathway formed within the material. The input follows the pathway and results in a particular desired output, wherein the input is determined and calculated based on the particular output received by the processor, and the pathway forms a logic circuit within the processor.

### BACKGROUND OF THE INVENTION

1. Field of the Invention

The present invention relates generally to an apparatus and method for information processing using lasing material. In particular, the present invention relates to a system that processes information by inputting energy into a lasing material, whereby the output influences additional lasing material to obtain a desired output. The lasing material has the potential to emit laser energy and the organization of the material computes information.

2. Discussion of the Related Art

What is needed, therefore, to overcome these inherent limitations of traditional information processing (heat, electromagnetic fields, frequency barriers, etc.), is a system for computing that relies on photons, whereby the only limitation is the speed of light.

### SUMMARY OF THE INVENTION

An apparatus and method for information processing using lasing material includes a processor that includes lasing material that is configured to route an input along a pathway formed within the material. The input follows the pathway and results in a particular desired output.

According to another aspect of the present invention, a system of information processing includes a processor that has lasing material configured to route an input along a pathway formed within the material. The input follows the pathway and results in a particular desired output, wherein the input is determined and calculated based on the particular output received by the processor, and the pathway forms a logic circuit within the processor.

According to yet another aspect of the present invention, a logic circuit includes a processor with lasing material configured to route an input along a pathway formed within the material, wherein the input follows the pathway and results in a particular desired output, and wherein the lasing material is a crystal.

### BRIEF DESCRIPTION OF THE DRAWINGS

A clear understanding of the various advantages and features of the present invention, as well as the construction and operation of conventional components and mechanisms associated with the present invention, will become more readily apparent by referring to the exemplary, and therefore non-limiting, embodiments illustrated in the following drawings which accompany and form a part of this patent specification.

FIG. 1 is an illustration of an atom according to the preferred embodiment of the present invention;

FIG. 2 is an illustration of an atom with electron transition to different orbits according to the preferred embodiment of the present invention;

FIG. 3 is an illustration of photons according to the preferred embodiment of the present invention;

FIG. 4 is an illustration of a ruby laser according to the preferred embodiment of the present invention;

FIG. 5 is an illustration of a flash tube firing and injecting light into a ruby rod according to the preferred embodiment of the present invention;

FIG. 6 is an illustration of the stimulation of photons as depicted in FIG. 5 according to the preferred embodiment of the present invention;

FIG. 7 is an illustration of a monochromatic, single-phase collimated light leaving the ruby according to the preferred embodiment of the present invention;

FIG. 8 is an illustration of the processor according to the preferred embodiment of the present invention;

FIG. 9 is an illustration of the input and output according to the preferred embodiment of the present invention;

FIG. 10 is an illustration of an application of the processor according to the preferred embodiment of the present invention; and

FIG. 11 is an illustration of a logic circuit according to the preferred embodiment of the present invention.

### DETAILED DESCRIPTION OF THE PREFERRED EMBODIMENTS

The limitations of traditional information processing are well-known including failure due to heat, electromagnetic fields, frequency barriers, cost of manufacture, etc. As described above, these limitations are eliminated with the use of laser technology.

### What is a Laser?

Lasers are in an amazing range of products and technologies. You will find them in everything from CD players to dental drills to high-speed metal cutting machines to measuring systems. These products all rely on laser technology.

There are only about 100 different kinds of atoms in the entire universe. Everything we see is made up of these 100 atoms in an unlimited number of combinations. The way in which these atoms are arranged and bonded together determines whether the atoms make up a cup of water, a piece of metal, or the fizz of soda.

Atoms are constantly in motion. They continuously vibrate, move and rotate. Even the atoms that make up the chairs that we sit in are moving around. Therefore, these solids are actually in motion. Atoms can be in different states of excitation. In other words, atoms can have different energies.

If a large amount of energy is applied to an atom, it can leave what is called the ground-state energy level and go to an excited level. The level of excitation depends on the amount of energy that is applied to the atom via heat, light, or electricity.

FIG. 1 illustrates the classic interpretation of an atom. An atom 10 consists of a nucleus 12, and a set of orbiting electrons 14 in an orbit 16. Nucleus 12 contains protons and neutrons and an electron cloud. Electrons 14 in this cloud circle nucleus in many different orbits 16.

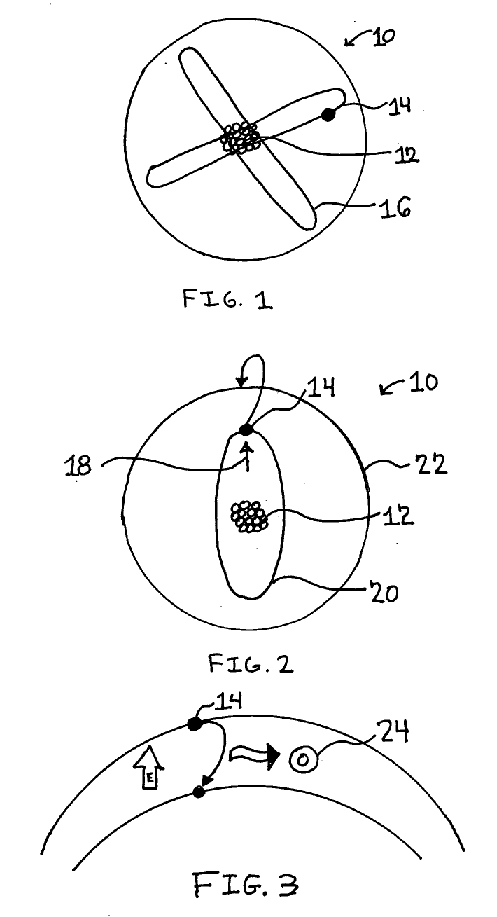

Although more modern views of the atom do not depict discrete orbits 16 for electrons 14, it is useful to think of these orbits 16 as the different energy levels of atom 10. As illustrated in FIG. 2, if heat 18 is applied to atom 10, some of the electrons 14 in a lower-energy orbital 20 will transition to a higher-energy orbital 22 farther away from nucleus 12.

Once an electron 14 moves to higher-energy orbit 22, it eventually wants to return to the ground state. When electron 14 returns to the ground state, it releases its energy as a photon—a particle of light. Atoms constantly release energy as photons. For example, when the heating element in a toaster turns bright red, the red color is caused by atoms, excited by heat, releasing red photons. The picture on a TV screen is actually phosphor atoms, excited by high-speed electrons, emitting different colors of light. Anything that produces light—fluorescent lights, gas lanterns, incandescent bulbs—emits this light through the action of electrons changing orbits and releasing photons.

### Lasers

A laser is a device that controls the way that energized atoms release photons. “Laser” is an acronym for light amplification by stimulated emission of radiation, which describes very succinctly how a laser works.

Although there are many types of lasers, all of them have certain essential features. In a laser, the lasing medium is “pumped” to get the atoms into an excited state. Typically, very intense flashes of light or electrical discharges pump the lasing medium and create a large collection of excited-state atoms (atoms with higher-energy electrons). It is necessary to have a large collection of atoms in the excited state for the laser to operate efficiently.

In general, the atoms are excited to a level that is two or three levels above the ground state. This increases the degree of population inversion. The population inversion is the number of atoms in the excited state versus the number in ground state.

Once the lasing medium is pumped, it contains a collection of atoms with some electrons sitting in excited levels. The excited electrons have energies greater than the more relaxed electrons. Just as the electron absorbed some amount of energy to reach this excited level, it can also release this energy.

FIG. 3 illustrates how electron 14 can simply relax, and in turn rid itself of some energy. This emitted energy comes in the form of photons 24 (light energy). Photon 24 emitted has a very specific wavelength (color) that depends on the state of the electron's energy when the photon is released. Two identical atoms with electrons in identical states will release photons with identical wavelengths.

Laser light is very different from normal light. Laser light has the following properties: (1) The light released is monochromatic. It contains one specific wavelength of light (one specific color). The wavelength of light is determined by the amount of energy released when the electron drops to a lower orbit. (2) The light released is coherent. It is “organized”—each photon moves in step with the others. This means that all of the photons have wave fronts that launch in unison. (3) The light is very directional. A laser light has a very tight beam and is very strong and concentrated. A flashlight, on the other hand, releases light in many directions, and the light is very weak and diffuse.

To make these three properties occur takes something called stimulated emission. This does not occur in your ordinary flashlight—in a flashlight, all of the atoms release their photons randomly. In stimulated emission, photon emission is organized.

The photon that any atom releases has a certain wavelength that is dependent on the energy difference between the excited state and the ground state. If this photon (possessing a certain energy and phase) should encounter another atom that has an electron in the same excited state, stimulated emission can occur. The first photon can stimulate or induce atomic emission such that the subsequent emitted photon (from the second atom) vibrates with the same frequency and direction as the incoming photon.

The other key to a laser is a pair of mirrors, one at each end of the lasing medium. Photons, with a very specific wavelength and phase, reflect off the mirrors to travel back and forth through the lasing medium. In the process, they stimulate other electrons to make the downward energy jump and can cause the emission of more photons of the same wavelength and phase. A cascade effect occurs, and soon we have propagated many, many photons of the same wavelength and phase. The mirror at one end of the laser is “half-silvered,” meaning it reflects some light and lets some light through. The light that makes it through is the laser light.

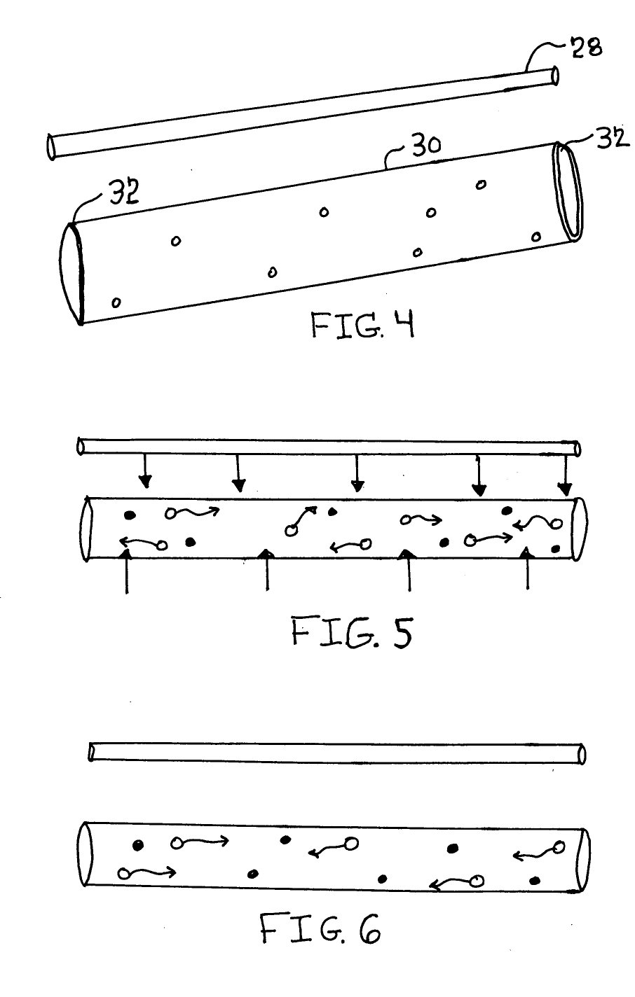

FIG. 4 illustrates a simple ruby laser in a non-lasing state. Laser 26 consists of a flash tube 28 (similar to that found on a camera), a ruby rod 30 and two mirrors 32 (one half-silvered). Ruby rod 30 is the lasing medium and flash tube 28 pumps it.

FIG. 5 illustrates flash tube 28 firing and injecting light into ruby rod 30. The light excites atoms in the ruby. In FIG. 6, some of these atoms emit photons and some of these photons run in a direction parallel to the ruby's axis, so they bounce back and forth off the mirrors. As they pass through the crystal, they stimulate emission in other atoms.

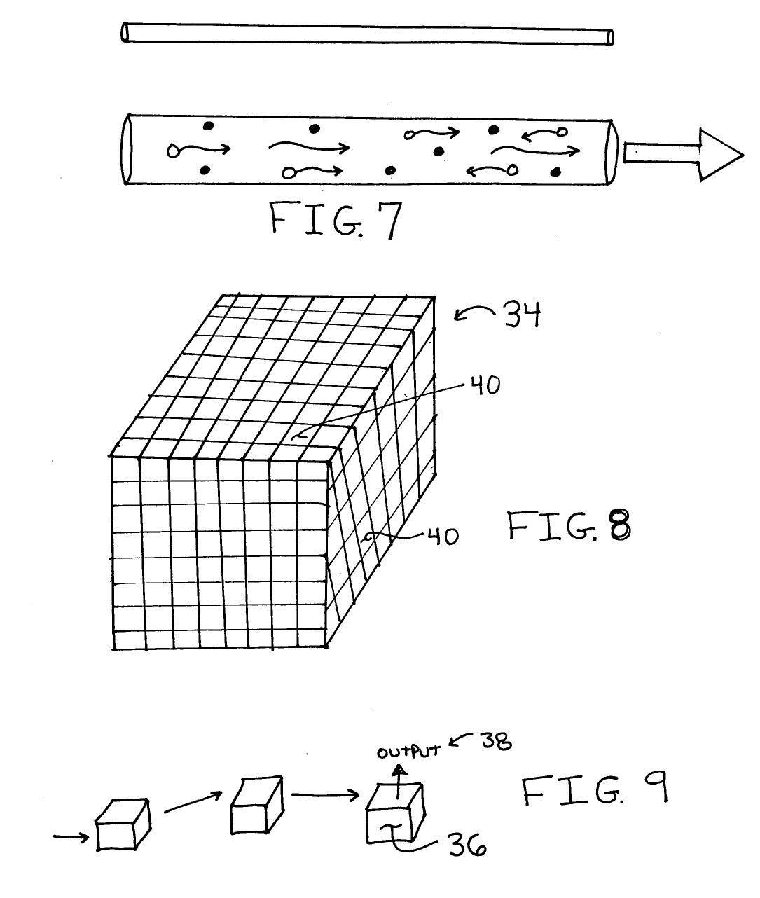

In FIG. 7, a monochromatic, single-phase, collimated light leaves the ruby through the half-silvered mirror as laser light.

### Types of Lasers

There are many different types of lasers. The laser medium can be a solid, gas, liquid or semiconductor. Lasers are commonly designated by the type of lasing material employed:
Solid-state lasers have lasing material distributed in a solid matrix (such as the ruby or neodymium:yttrium-aluminum garnet “Yag” lasers). The neodymium-Yag laser emits infrared light at 1,064 nanometers (nm). A nanometer is 1×10⁻⁹ meters.
Gas lasers (helium and helium-neon, HeNe, are the most common gas lasers) have a primary output of visible red light. CO2 lasers emit energy in the far-infrared, and are used for cutting hard materials.
Excimer lasers (the name is derived from the terms excited and dimers) use reactive gases, such as chlorine and fluorine, mixed with inert gases such as argon, krypton or xenon. When electrically stimulated, a pseudo molecule (dimer) is produced. When lased, the dimer produces light in the ultraviolet range.
Dye lasers use complex organic dyes, such as rhodamine 6G, in liquid solution or suspension as lasing media. They are tunable over a broad range of wavelengths.
Semiconductor lasers, sometimes called diode lasers, are not solid-state lasers. These electronic devices are generally very small and use low power. They may be built into larger arrays, such as the writing source in some laser printers or CD players.

A ruby laser as described above is a solid-state laser and emits at a wavelength of 694 nm. Other lasing mediums can be selected based on the desired emission wavelength (see table below), power needed, and pulse duration.

Some lasers are very powerful, such as the CO2 laser, which can cut through steel. The reason that the CO2 laser is so dangerous is because it emits laser light in the infrared and microwave region of the spectrum. Infrared radiation is heat, and this laser basically melts through whatever it is focused upon.

Other lasers, such as diode lasers, are very weak and are used in today's pocket laser pointers. These lasers typically emit a red beam of light that has a wavelength between 630 nm and 680 nm. Lasers are utilized in industry and research to do many things, including using intense laser light to excite other molecules to observe what happens to them.

Here are some typical lasers and their emission wavelengths:

| Laser Type | Wavelength (nm) |
|---|---|
| Argon fluoride (UV) | 193 |
| Krypton fluoride (UV) | 248 |
| Nitrogen (UV) | 337 |
| Argon (blue) | 488 |
| Argon (green) | 514 |
| Helium neon (green) | 543 |
| Helium neon (red) | 633 |
| Rhodamine 6G dye (tunable) | 570-650 |
| Ruby (CrAlO₃) (red) | 694 |
| Nd:Yag (NIR) | 1064 |
| Carbon dioxide (FIR) | 10600 |

### Laser Classifications

Lasers are classified into four broad areas depending on the potential for causing biological damage.
Class I—These lasers cannot emit laser radiation at known hazard levels.
Class I.A.—This is a special designation that applies only to lasers that are “not intended for viewing,” such as a supermarket laser scanner. The upper power limit of Class I.A. is 4.0 mW.
Class II—These are low-power visible lasers that emit above Class I levels but at a radiant power not above 1 mW. The concept is that the human aversion reaction to bright light will protect a person.
Class IIIA—These are intermediate-power lasers (cw: 1-5 mW), which are hazardous only for intrabeam viewing. Most pen-like pointing lasers are in this class.
Class IIIB—These are moderate-power lasers.
Class IV—These are high-power lasers (cw: 500 mW, pulsed: 10 J/cm² or the diffuse reflection limit), which are hazardous to view under any condition (directly or diffusely scattered), and are a potential fire hazard and a skin hazard. Significant controls are required of Class IV laser facilities.

### What is a Crystal?

Crystals are structures that are formed from a regular repeated pattern of connected atoms or molecules. Crystals grow by a process termed nucleation. During nucleation, the atoms or molecules that will crystallize (solute) are dissolved into their individual units in a solvent.

The solute particles contact each other and connect with each other. This subunit is larger than an individual particle, so more particles will contact and connect with it. Eventually, this crystal nucleus becomes large enough that it falls out of solution (crystallizes).

Other solute molecules will continue to attach to the surface of the crystal, causing it to grow until a balance or equilibrium is reached between the solute molecules in the crystal and those that remain in the solution.

### What is a Semiconductor?

A semiconductor is a material, typically crystaline, which allows current to flow under certain circumstances. Common semiconductors are silicon, germanium, gallium arsenide.

Semiconductors are used to make diodes, transistors and other basic “solid state” electronic components.

As crystals of these materials are grown, they are “doped” with traces of other elements called donors or acceptors to make regions which are n- or p-type respectively for the electron model or p- or n-type under the hole model.

Where n and p type regions adjoin, a junction is formed which will pass current in one direction (from p to n) but not the other, giving a diode.

One model of semiconductor behavior describes the doping elements as having either free electrons or holes dangling at the points in the crystal lattice where the doping elements replace one of the atoms of the foundation material.

When external electrons are applied to n-type material (which already has free electrons present) the repulsive force of like charges causes the free electrons to migrate toward the junction, where they are attracted to the holes in the p-type material—thus, the junction conducts current.

In contrast, when external electrons are applied to p-type material, the attraction of unlike charges causes the holes to migrate away from the junction and toward the source of external electrons. The junction thus becomes “depleted” of its charge carriers and is non-conducting.

### Information Processing using Lasing Material

FIG. 8 illustrates a crystal processor 34 according to the present invention. Each crystal 36 is influenced by different inputs (pulses). As crystals 36 are grown, they are doped at different levels to form pathways or coated with filters to form pathways. The input (photon) follows the particular path and results in a particular desired output 38. Output surfaces 40 are predetermined by the user and outputs are manipulated depending on the particular application in which crystals 36 are being used.

In particular, information is processed by inputting energy into lasing material 34 and the output influences additional lasing material to obtain output 38. This eliminates limitations imposed by binary processing. Lasing material 34 is not limited to any particular crystal. In this regard, lasing material 34 is a material that emits energy (photons) when electrons are excited and return to their original state. The decision to choose a specific lasing material is based on the frequencies of the photons emitted from output 38. Therefore, the frequencies at output 38 determine which material is chosen as material 34.

As discussed above, as illustrated in FIG. 9, the crystals are grown to accept photons at certain frequencies. The lasing material is a material that emits photons when stimulated by radiation. For example, crystal 34 may be a ruby or it may be an inorganic compound such as chlorophyll. The particular crystals are grown to form crystal structure 34. Cube 34 is a combination of individual crystals 36, but structure 34 may also be designed as a different geometric shape (e.g., a sphere) depending on the application in which it is used.

For example, if structure 34 is used in a particular shaped container like for use in a watch, the crystals 36 are assembled into a structure that “fits” into the given container. When individual crystals 36 are assembled into structure 34, a maze of predetermined pathways are formed where there are multiple exits from structure 34.

The input is determined and calculated based on the particular output received by the processor. The precise nature of the pathways allow a user to apply crystals to any information processing necessary in a larger algorithm or structure including language algorithms, pathway math, video game rendering (curvature), etc.

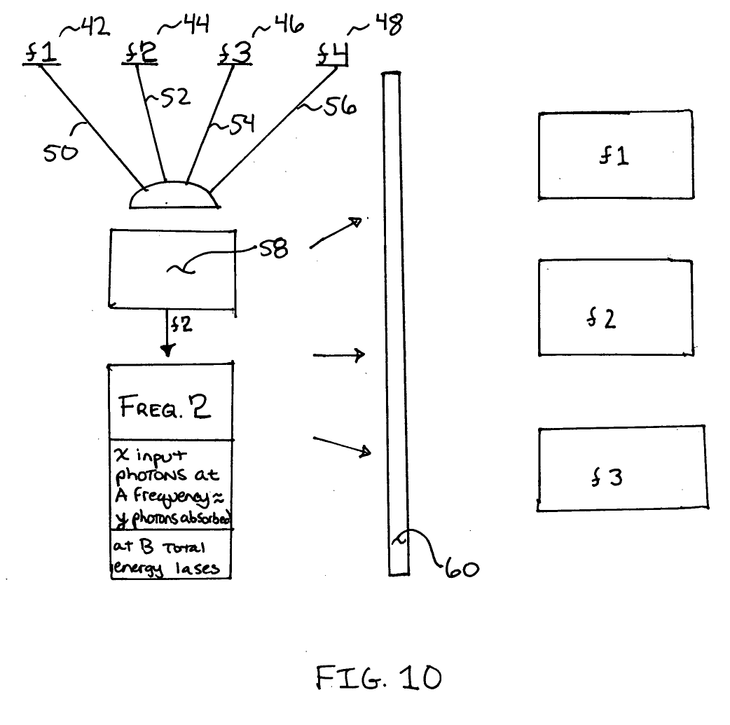

FIG. 10 is an illustration on one type of application of structure 34. In a variable frequency math application, a set of frequencies 42, 44, 46 and 48 correspond to a first, second, third and fourth frequency, respectively, wherein photons follow a path 50, 52, 54 or 56. A crystal 58 (e.g., a ruby) lases at a particular frequency (e.g, frequency 2). The input frequency excites photons and then outputs at a different frequency. A filtered collector 60 filters output.

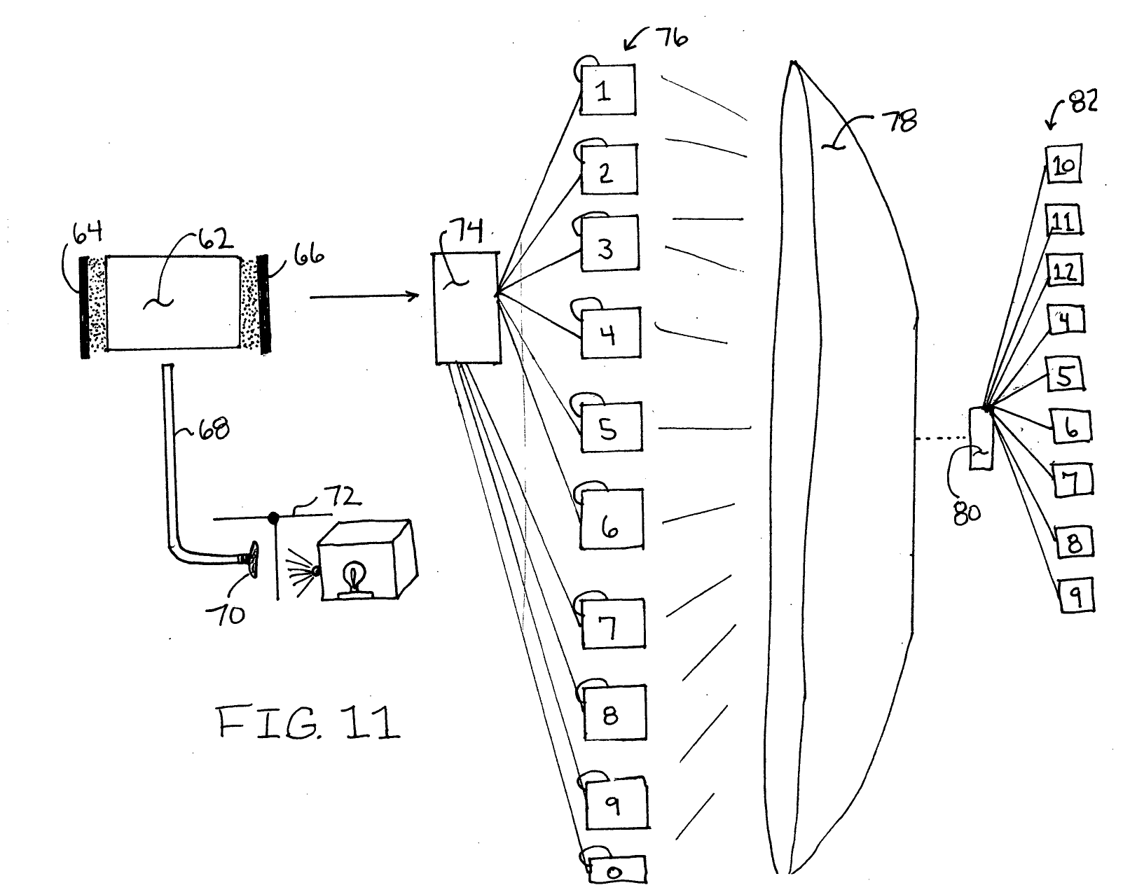

FIG. 11 illustrates a pulse accumulation math including a lasing material 62, a full mirror 64, a partial mirror 66, a light path 68,.a collector 70, and a physical gate 72 wherein the pulse is a constant with the same duration and energy. A beam splitter 74 is linked to a set of outputs 76. The system further includes a collector 78, a splitter 80 and a set of outputs 82.

### Crystals—Growing and Doping History

Crystal detectors using semiconducting sulfides and oxides (e.g. CuO, PbS (galena)) were widely used in the early days of radio but became obsolete with the invention of the vacuum diode tube, which is a much more reliable and stable device. Interest in crystal detectors was revived with the coming of radar in the late 1930's when it was recognized that radar could be further improved only by utilizing short wavelengths below the 10 cm range for the transmitting beam.

At about that time, (1939), a compact source of microwaves of about 10 cm wavelength became available with the invention of the magnetron by J. T. Randall and H. A. H. Boot at the University of Birmingham. To take advantage of this improvement, it was necessary to devise a receiver effective at these shorter wavelengths as well. Unfortunately, the receivers used for the longer wavelength radar had at their hearts the vacuum tube diode which became unstable and thus unusable at the higher frequencies. Thus a vast program of research was initiated in the U.S. to develop effective, point contact crystal rectifiers for use with radar.

By comparison to vacuum tube diodes, crystal rectifiers, because of their low capacitance could operate better at microwave frequencies, and because of their small size and low power requirements were expected to be very useful in microwave radar receivers. Rectifiers of silicon had already been successfully employed in the “red-dot” detectors developed in England.

Now Lark-Horovitz, as a first lieutenant in the Austrian Signal Corps, in World War I, had operated a crystal radio for his section and had in addition worked on crystal detectors as an assistant at the University of Vienna in the 1920's. It was thus natural for him to propose to the Radiation Lab (on 24 Jan. 1942) a vaguely stated research program that included: construction of a 10 cm emitter; investigation of crystal faces by electron diffraction and electron optics, and the investigation of various detector combinations for sensitivity and ability to withstand shock, etc. The proposal made no mention of germanium but dwelt exclusively with galena (lead sulfide) as rectifying material.

Following the Radiation Lab's approval of the proposal, in March 1942, Purdue's efforts quickly turned to germanium as a rectifying material when the galena rectifier, which worked well at long wavelengths became unstable at 30 cm. Prior to working on germanium, the group also worked briefly with silicon rectifiers but dropped this research when it realized that it had been well studied in Britain and by the Radiation Lab at MIT in the U.S. That germanium was also capable of producing rectifying action was already known at the time from the literature; indeed germanium rectifiers had already been introduced into microwave technology by the Sperry Gyroscope Co.

However, there were many serious problems in using germanium for this purpose; foremost was the poor performance of the germanium crystal rectifiers due to their instability and their inhomogeneity, because of the lack of purity of the available semiconducting material. Lark-Horovitz's idea to study germanium as a suitable rectifying material was immediately accepted by the Radiation Lab and led to the modified contract between Purdue and the Office of Scientific Research and Development, a unit of the National Defense Research Council, to supplement the efforts of the Radiation Laboratory, in improving radar technology.

In part, Lark-Horovitz' goal in taking on the contract was to utilize the department's resources to support the national war effort as well as to obtain research support for a dwindling number of staff members and graduate students in the department. Nevertheless, it was a first step in developing at Purdue a program in semiconductor research which would lead to international recognition lasting long after the end of the war.

The element germanium has an interesting history. It was first predicted to exist in 1870 by the Russian chemist Mendelejeff who named it Eka-silikon, and was discovered physically 13 years later in 1883 by the German chemist Winkler who found it had precisely the properties earlier predicted by Mendelejeff. For a long time it was thought to be a very rare element. The comparatively wide distribution of germanium, particularly in silicate materials, was only discovered much later in 1930 by a group of chemists at Cornell University and simultaneously by a group in Gottingen and other groups in Europe. They found that there are about 7 grams per ton of germanium in sediment minerals as compared, for example, with 40 grams per ton of tin. Thus its distribution and availability was far greater than originally anticipated.

As is carbon, germanium is tetravalent and crystaline (at room temperature) and belongs-along with carbon, silicon, tin and lead—to the fourth column of the periodic table. The pure substance is an intrinsic semiconductor, as is silicon, and is characterized by the fact that its electrical properties can be changed over a wide range by the addition of certain impurities, a process called doping. Eventually it was recognized that the addition of impurities from the third column of the periodic table, such as aluminum, galium and indium, produces a “p-type” semiconductor in which conduction is via positive charge carriers.

While the addition of impurities from the fifth column of the periodic table, such as phosphorous, arsenic and antimony, produces “n-type” semiconductors in which the electrical carriers are negative as in ordinary metals. It is this versatility associated with doping that enables one to control the electrical properties of semiconductors and makes them of such wide importance in industrial applications and thus for the war effort.

With a contract from the National Defense Research Council (NRDC) at hand, Lark-Horovitz recruited some half a dozen professional faculty members (R. N. Smith, H. J. Yearian, I. Walerstein, E. P. Miller, V. Johnson, and for a short time, R. Sachs) from within the wartime-depleted Purdue staff. They had diverse backgrounds (in x-ray and electron diffraction, nuclear physics, cosmic rays, and spectroscopy) and were assisted by about a dozen beginning graduate students. Certainly, none of the participants had any prior experience with metallurgy, crystal growth, semiconductors or microwave radar, except Lark-Horovitz who had worked with CuO rectifiers in the Signal Corps of the Austrian army during World War I.

These accomplishments appear even more astounding when it is realized how little was generally known at that time about semiconductors. There was even some question, at least in Lark-Horovitz's mind, whether germanium, the eventual target of Purdue's research, was a semiconducting material at all. At the time there was no such thing as a materials science, and no facilities for growing single crystals. The growth and doping of crystals to control semiconductor properties was hardly a science, and not even an art in those days, as evidenced by the fact that the initial polycrystalline, inhomogeneous germanium ingots grown at Purdue were doped with elements from a good portion of the periodic table in order to determine which would make the best diodes. When the Purdue final report on the semiconductor project was written after the war, it was stated that helium and tin doping gave the best rectifiers. It was not recognized that it was the impurities in these dopants which were responsible for controlling the electrical properties of the germanium samples. (The elements, helium and tin, have no influence on the electrical properties of semiconductors.) Ultimately it was recognized that Group III impurities produce p-type materials, and Group V impurities produce n-type materials.

Of course, just as for wartime nuclear physics, research on the germanium project was carried out under strict wartime secrecy. Results were given in secret reports only to those with appropriate clearance and a “need to know”. Towards the end of 1945, all of the Purdue research on semiconductors was declassified.

As orchestrated by Lark-Horovitz, the research on the development of point contact crystal rectifiers at Purdue was a model of scientific organization. Although, as conceived and contracted for, the project was mainly of an applied nature, Lark-Horovitz insisted that it be supported by a variety of studies involving basic research. Lark-Horovitz and Vivian Johnson, for example, carried out many theoretical analyses of the data obtained. The work itself was divided among three mutually supporting groups.

The most important among these initially was the group dealing with the purification of germanium. Since no available external source of germanium crystals was available, it was necessary to build a facility for purification and crystal growth of relatively pure, high resistivity germanium crystals.

Purified germanium oxide was provided by the Eagle-Picher Co. in Missouri. Randall M. Whaley who headed this part of the project developed techniques for purifying germanium dioxide (GeO₂) powder and subsequently reducing it in hydrogen.⁽¹⁴⁾ The residue was then subject to prolonged heating in a vacuum to purify it.⁽¹⁵⁾ He grew the first germanium ingots. Controlled coping with impurities was achieved to vary the resistivity and to give either p-type or n-type material. Although the materials were inhomogeneous and polycrystalline, it was possible to cut selected samples for Hall and resistivity measurements, and for making diodes.

With doped germanium crystals available, their electrical and galvanomagnetic properties (resistivity, Hall effect and thermoelectric power) were then measured and analyzed by I. Walerstein, and E. P. Miller, and supported by students, A. Middleton and W. Scanlon. Such measurements were necessary to characterize the germanium ingots after they were grown, and to provide the necessary feedback for improving the crystal growth techniques. The theoretical analysis of the results by Lark-Horovitz and V. A. Johnson established the basic semiconducting properties of germanium: the width of the intrinsic energy gap and the activation energies of various impurities.

From the temperature dependence of the mobility of electrons and holes, the relative contributions of lattice and impurity scattering could be determined. This work became the basis for making germanium the prototype semiconducting material. A helpful contribution to the analysis was made by Victor Weisskopf and his student Esther Conwell at Rochester University who, at the suggestion of Lark-Horovitz, derived an expression for the cross-section for scattering of free carriers by ionized impurities, a vital factor in analyzing the mobility of the carriers.

The third and largest group was responsible for the fabrication, testing and evaluation of the final crystal rectifiers. It consisted of Hubert J. Yearian and Ronald Smith plus a number of graduate students and assistants. Notable among the latter was Seymour Benzer who was to make one of the decisive discoveries in the project and to go on, after receiving the Ph.D. in physics, to become widely recognized in the fields of molecular biology and neurobiology.

The crowning technological achievement of this group was the manufacture of high quality crystal diodes by a process which was ultimately patented by Purdue. The factors in this success were the production of good germanium material, the development of successful surface chemical etching techniques and the discovery of the process of “welding” the tungsten “whiskers” unto the germanium chips. This generated extremely stable diodes, which could sustain high back (or reverse) voltages (>100 V), without the unstable, burnout problems of the then existing silicon diodes. The technological contribution of these diodes became much more important after the war, and in fact stimulated the establishment of the post-war semiconductor industry.

Thus, despite the initial lack of expertise and experience of everyone in the project—with the possible exception of Lark-Horovitz—and despite the limited fiscal and physical resources available, the work of the group was incredibly successful. As perceived by the leader of the project, in a report written shortly after the war, and entitled History of Germanium Development at Purdue, Lark-Horovitz gave a chronology of events as follows:
January 1942: Dr. James submits a number of problems to be worked on outside of the Radiation Laboratory, among them the problem of crystal detectors. Because of my experience in this field it was offered to the Radiation Laboratory that the Purdue group should engage in this type of work.
January-February 1942: V isits to various installations and discussions to learn the present status of detector development. Literature study . . . Sperry Gyroscope Laboratory had introduced at this time crude germanium as a detector. Literature studies on germanium detectors.
March 1942: Organization of the Purdue group with the program to purify germanium. Whaley's experiments on purification of germanium using all methods known at this time. First experiments on melting under helium, hydrogen reduction, etc.
May 1942: Meeting at M.I.T. Present: EU. Condon (Westinghouse), F. Seitz (University of Pennsylvania), H. Q. North (General Electric), T. A. Becker (Bell Telephone), N. Rochester (Radiation Laboratory), K. Lark-Horovitz and R. G. Sachs (Purdue) . . . K. Lark-Horovitz announced the production of p- and n-type germanium by addition of either boron, aluminum, gallium, indium or arsenic, bismuth from the other series. The next day North approached K. Lark-Horovitz and asked for permission to work on germanium at General Electric.
Development of purification and production of larger ingots during May, June and July. First detector units produced in the summer of 1942.
August 1942: Visit of Rochester to Purdue and assignment to investigate “burn-out” in germanium crystals . . . Lark-Horovitz announced for the first time that germanium and silicon are intrinsic semiconductors, as substantiated by findings at the University of Pennsylvania and also by findings in the literature, but not recognized before.
September 1942: During burn-out experiments Benzer discovered that welded units with whiskers will still rectify. Lark-Horovitz pointed out that D.C. welding might be used for production of units. High-back-voltage characteristics observed in some materials by Benzer . . . Purdue group divided into three essential units: (a) electrical measurements of Hall effect, resistivity, thermoelectric power under K. Lark-Horovitz, (b) purification and melting—R. M. Whaley, (c) bum-out and high-back-voltage rectifiers—S. Benzer, R. F. properties—H. J. Yearian and R. N. Smith, theory—first R. G. Sachs, then V. A. Johnson.
Spring 1943: High back voltage observed first in Whaley's high vacuum experiments. Continuation of these experiments by Benzer led to high back-voltage diode.
Summer 1943: High back voltage observed up to 150 volts and reported at Radiation Laboratory meeting in October 1943.
October 1943: Conference with H. Q. North, General Electric pointing out the possibilities of future germanium development. Assignment of mass production to Bell Telephone Laboratories. Purdue has the duty to supervise development and to meet regularly every six months at the Bell Telephone Laboratories with a group from National Defense Research Corporation (NDRC) and a group from the armed services.
Spring 1944: Purdue group succeeds in interpreting resistivity and thermoelectric behavior of germanium semiconductors. R. F. testing methods introduced by R. N. Smith (Purdue) are accepted by all NDRC groups. Reports on capacity measurements by R. N. Smith, high frequency measurements by Yearian, measurements of the static characteristics and determination of the rectification coefficient . . .
Fall 1945: At the end of the war the Purdue group had (a) shown electrical properties to be predictable from impurity content, (b) predicted resistivity and thermoelectric power in the range of temperature available at this time (down to liquid air temperature) from the number of electrons given by Hall effect measurement, (c) determined the mobility ratio for holes and electrons. First infrared measurements by K. Lark-Horovitz and K. W Meissner yielded the dielectric constant for Si≈13, for Ge≈16-17.
High-back-voltage rectifiers were perfected and the present-type cartridge introduced by R. N. Smith. Methods of melting and production of high-purity ingots brought to high perfection by R. M. Whaley. The group decides to abandon development of detectors and the practical applications and to concentrate primarily on the basic investigation of germanium semiconductors.

While much of the war-time semiconductor work at Purdue received immediate world-wide recognition, the significance of the anomalous properties was not initially appreciated either at Purdue or elsewhere. Recognition of their significance had to await post-war work at Purdue and the invention of the point-contact transistor by John Bardeen and Walter Brattain at Bell Labs a few years after the war, in December 1947.

Most computer chips today consist of tiny electrical and electronic components on a thin slice of silicon crystal. As many as five million discrete components can be placed on a piece of crystal less than two inches square. Silicon crystal chips, however, are quite sensitive to heat. Electricity passing through a chip's super-thin connecting wires creates heat, just as it does in the heating element of a toaster. If too much heat builds up, the chip loses its functionality.

The scope of the application is not to be limited by the description of the preferred embodiments described above, but is to be limited solely by the scope of the claims that follow. For example, instead of relying on photons, another form of energy may be used in the processor without departing from the scope of the preferred embodiment of the present invention.

1. An apparatus for information processing comprising:
a processor including lasing material configured to route an input along a pathway formed within the material, wherein the input follows the pathway and results in a particular desired output.

2. The apparatus according to claim 1, wherein the input is determined and calculated based on the particular output received by the processor and energy is emitted when an electrons is excited and returns to its original state.

3. The apparatus according to claim 1, wherein the processor includes a maze of pathways.

4. The apparatus according to claim 3, wherein the placement of the pathways allows a user to process information in a specific algorithm.

5. The apparatus according to claim 4, wherein the algorithm includes processing language.

6. The apparatus according to claim 4, wherein the algorithm includes processing complex curvatures including video game rendering.

7. The apparatus according to claim 1, wherein the lasing material is a crystal.

8. The apparatus according to claim 4, wherein the pathway is formed by doping crystals.

9. The apparatus according to claim 1, wherein the input is a photon.

10. The apparatus according to claim 7, wherein the crystal emits photons when stimulated by radiation.

11. The apparatus according to claim 10, wherein the crystals are grown to accept photons at certain frequencies.

12. The apparatus according to claim 11, wherein the crystals form a geometric structure.

13. The apparatus according to claim 12, wherein the geometric structure depends on the application of the apparatus.

14. The apparatus according to claim 13, wherein the geometric structure is molded to fit within a particular container.

15. The apparatus according to claim 14, wherein the structure is a cube.

16. The apparatus according to claim 14, wherein the structure is a sphere.

17. The apparatus according to claim 12, wherein the structure further comprises multiple pathways having corresponding multiple exits.

18. A system of information processing comprising:
a processor including lasing material configured to route an input along a pathway formed within the material, wherein the input follows the pathway and results in a particular desired output, wherein the input is determined and calculated based on the particular output received by the processor, and the pathway forms a logic circuit within the processor.

19. The system according to claim 18, wherein the input changes the information processed by the processor.

20. A logic circuit comprising:
a processor including lasing material configured to route an input along a pathway formed within the material, wherein the input follows the pathway and results in a particular desired output, and wherein the lasing material is a crystal.
